(19) United States
(12) Patent Application Publication
(10) Pub. No.: US 2008/0035181 A1
(43) Pub. Date: Feb. 14, 2008

(54) Cleaning apparatus

(75) Inventors: Hirohiko Takahashi, Tokyo (JP); Takashi Fujita, Tokyo (JP)

Correspondence Address: PAUL A. FATTIBENE;FATTIBENE & FATTIBENE, 2480 POST ROAD, SOUTHPORT, CT, 06890, US

(73) Assignee: TOKYO SEIMITSU CO., LTD.

(21) Appl. No.: 11/888,689

(22) Filed: Aug. 2, 2007

(30) Foreign Application Priority Data
Aug. 9, 2006 (JP) 2006-217572
May 24, 2007 (JP) 2007-138437

(51) Int. Cl. B08B 3/10

(52) U.S. Cl. 134/61

(57) ABSTRACT

It is an object of the invention to provide a cleaning apparatus which can subject wafers that have undergone polishing to various cleaning processes while reducing the usage amount of pure water, increase the processing speed of wafers per unit floor area and significantly improve the operating rate, enable change or rearrangement of a plurality of cleaning processing chambers to more optimum arrangement in accordance with the cleaning treatment processes and the like, prevent generation of defects in wafers that are in process of, for example, pre-treatment, and simplify the configuration of the apparatus.

In order to achieve the above described object, the present invention provides a cleaning apparatus comprising cleaning lines 2A and 2B comprised of lower and upper two levels, each of the levels comprising a plurality of cleaning processing chambers 2a to 2d or 2e to 2h; a center transporting means 6 comprising a function of transporting a wafer to be processed into or a function of transporting the processed wafer from each of the cleaning processing chambers 2a to 2h in the lower-layer and upper-layer cleaning lines 2A and 2B; an inter-chamber transporting means 16 for sequentially transporting the wafer to the adjacent cleaning processing chamber in each of the lower-layer and upper-layer cleaning lines 2A and 2B; and an introducing means for introducing pure water used in the cleaning processing chamber, which carries out precision cleaning in the upper-layer cleaning line 2B, into the cleaning processing chamber, which carries out rough cleaning in the lower-layer cleaning line 2A, as washing water for the rough cleaning.

### FIELD OF THE INVENTION

The present invention relates to a cleaning apparatus and particularly relates to a cleaning apparatus which cleans wafers polished by chemical mechanical polishing (CMP: Chemical Mechanical Polishing) or the like.

### BACKGROUND OF THE INVENTION

Wafers of semiconductor devices, electronic parts, or the like undergo various processes such as cutting and polishing. Recently, development in semiconductor techniques have promoted miniaturization and multi-layer interconnection in the design rules of semiconductor integrated circuits, and increase in the diameter of wafers have been also promoted in order to reduce cost. Therefore, when a next pattern is formed on a pattern-formed layer without processing in a conventional manner, forming a good pattern in the next layer is difficult due to the irregularities of the previous layer, defects, or the like are easily generated.

Therefore, a planarization process in which the surface of the pattern-formed layer is planarized and the pattern of the next layer is then formed is carried out. CMP has been frequently carried out in the planarization process. Polishing of a wafer by CMP is carried out by retaining the wafer by a polishing head, bringing the wafer into contact with a polishing pad with a pressure while supplying slurry, which is a mixture of an abrasive and a chemical agent, and rotating the wafer and/or the polishing pad in this state.

Large amounts of particles of, for example, the used abrasive, metal impurities contained in the chemical agent, ions and fine particles of the metal used in metal wiring on the wafer, or the like are adhering on the wafer surface after polishing by the CMP. Since these particles, or the like have adverse effects on semiconductor devices or the like which serve as products, the surfaces of wafers after polishing have to be cleaned to have high cleanliness so that the particles, ions and fine particles of the metal impurities, or the like, are removed.

For example, the following polishing apparatus and substrate processing apparatus are known as conventional techniques relating to such a cleaning apparatus. In this conventional technique, primary to fourth four cleaning machines (cleaning processing chambers) for cleaning wafers, which have undergone CMP polishing, are separated from each other by dividing walls and arranged in one direction. In addition, transporting mechanisms for sequentially transporting wafers to next cleaning machines are provided. The primary and secondary cleaning machines rotate roll-like sponges, which are disposed above and below, and press the sponges against a first surface and a second surface of the wafer, thereby cleaning the first surface and the second surface of the wafer. The third cleaning machine presses a hemispherical sponge against the wafer while rotating the sponge, thereby cleaning the wafer. The fourth cleaning machine subjects the second surface of the wafer to rinse cleaning and cleans the first surface by pressing a hemispherical sponge against the first surface while rotating the sponge. A spin dry function for drying the wafer after the cleaning by rotating the wafer at a high speed is provided. At the top of each of the primary to fourth cleaning machines, a filter fan unit comprising a clean air filter is provided, and clean air without particles is always blown downwardly from the filter fan unit (for example, see Patent Document 1).

For example, a following substrate processing method is known as another conventional technique related to the cleaning apparatus. In this conventional technique, first to fourth four cleaning processing chambers for cleaning wafers, which have undergone CMP polishing, are arranged in one direction. In addition, transporting apparatus for sequentially transporting wafers to next cleaning processing chambers are provided. The first cleaning processing chamber causes an organic alkaline treatment liquid to drip from a cleaning fluid supplying nozzle and drive a pair of rotating brushes to rotate in the opposite directions, thereby bringing both the first and second surfaces of a wafer into contact with protruding portions of the pair of rotating brushes and cleaning the wafer. When cleaning using the organic alkaline treatment liquid is completed, pure water is supplied to both the first and second surfaces of the wafer, thereby cleaning particles, or the like which have got away from the wafer. The second cleaning processing chamber causes an organic acid treatment liquid from a cleaning fluid supplying nozzle and drives a pair of rotating brushes to rotate in the opposite directions, thereby bringing both the first and second surfaces of the wafer into contact with protruding portions of the pair of rotating brushes and cleaning the wafer. When the cleaning using the organic acid treatment liquid is completed, pure water is supplied to both the first and second surfaces of the wafer, thereby cleaning metal impurities, or the like which have got away from the wafer. The third cleaning processing chamber supplies pure water to the first surface of the wafer to form a liquid film, at the same time, supplies a highly-oxidative treatment liquid to the second surface of the wafer, and cleans the wafer while rotating the wafer. Then, the fourth cleaning processing chamber subjects both the first and second surfaces of the wafer to precision cleaning by pure water excited by ultrasonic waves and then subjects the wafer to spin drying. In this precision cleaning, fine particles, metal impurities, or the like adsorbed on the part of dishing or the like generated in metal wiring on the wafer can be reliably cleaned. In the fourth cleaning processing chamber, a discharge duct for discharging pure water during cleaning or after cleaning is provided (for example, see Patent Document 2).

[Patent Document 1] Japanese Patent Application Laid-Open (kokai) No. 2003-309089 (pages 8, 18, 19, and FIG. 1)

[Patent Document 2] Japanese Patent Application Laid-Open (kokai) No. 2002-299300 (pages 5, 10 to 13, FIG. 2, and FIG. 4)

In the conventional technique described in Patent Document 1, wafers, which have undergone polishing of CMP, are subjected to cleaning processes while the wafers are sequentially transported from the primary to fourth cleaning machines and dried in the last fourth cleaning machine so as to finish the cleaning process. Since the wafers are sequentially processed in the four cleaning machines, which are arranged in one direction, one by one, the processing number of wafers per unit time in the entire cleaning apparatus is limited by the cleaning time of the cleaning machine that has the longest processing time among the four cleaning machines. When the cleaning process of wafers is stopped due to failure or the like of any of the four cleaning machines, insufficient processing is caused in the wafers in process such as pretreatment. Furthermore, the transporting order from the primary cleaning machine to the last fourth cleaning machine is fixed in the cleaning apparatus due to the structure thereof, and the processing order cannot be changed in accordance with, for example, cleaning treatment processes. In the entire primary to fourth cleaning machines, purified clean air is always supplied from the above thereof by the filter fan unit.

In the conventional technique described in Patent Document 2, the point that a cleaning process is carried out while sequentially transporting wafers after polishing from the first to fourth cleaning processing chambers and the wafers are dried in the last cleaning processing chamber to finish the cleaning process is approximately the same as the conventional technique described in above described Patent Document 1. Then, in the conventional technique described in above described Patent Document 2, the pure water used merely in the precision cleaning of the fourth cleaning processing chamber is discharged from the discharge duct. The pure water that is used merely in precision cleaning and maintaining not-largely deteriorated purity can be conceivably recycled in the series of cleaning processes starting from a removing process of an abrasive or the like adhering on the wafers after polishing.

Thus, technical problems to be solved are generated in order to subject wafers that have undergone polishing to various cleaning processes or to subject wafers that have undergone polishing to many cleaning processes while reducing the usage amount of pure water, to increase the processing speed of wafers per unit floor area and significantly improve the operating rate, to enable change or rearrangement of a plurality of cleaning processing chambers to optimum arrangement in accordance with the cleaning treatment processes or the like to prevent generation of defects in wafers that are in process of, for example, pre-treatment, to reduce the cost of supplying equipment and simplify the configuration of the apparatus, and to suppress transmission of the vibration that is generated in the cleaning processing chambers in an upper-layer side to other cleaning processing chambers, and obtain always stable cleaning property. It is an object of the present invention to solve these problems.

### SUMMARY OF THE INVENTION

The present invention has been proposed for achieving the above described objects, and the invention according to claim 1 provides a cleaning apparatus comprising: cleaning lines comprised of lower and upper two levels, each of the levels comprising a plurality of cleaning processing chambers which subjects a wafer, which has undergone polishing, to a required cleaning process and drying; a center transporting means comprising a function of transporting the wafer, which has undergone polishing, into or transporting the processed wafer to each of the cleaning processing chambers in the lower-layer and upper-layer cleaning lines; and an inter-chamber transporting means for sequentially transporting the wafer to the adjacent cleaning processing chamber in each of the lower-layer and upper-layer cleaning lines.

According to this configuration, when a series of processes is to be carried out merely in the lower-layer cleaning line, the wafer, which has undergone polishing such as chemical mechanical polishing, is transported to the cleaning processing chamber in the former side in the lower-layer cleaning line by the center transporting means. The transported wafer is subjected to required cleaning processes while the wafer is sequentially transported to the adjacent cleaning processing chambers by the inter-chamber transporting means, and the wafer is subjected to a drying process in the last cleaning processing chamber and carried out therefrom.

When a series of processes is to be carried out merely in the upper-layer cleaning line, the wafer, which has undergone polishing, is transported into the cleaning processing chamber in the former side in the upper-layer cleaning line by the center transporting means. The transported wafer is subjected to required cleaning processes while the wafer is sequentially transported to the adjacent cleaning processing chambers by the inter-chamber transporting means, and the wafer is subjected to a drying process in the last cleaning processing chamber and carried out therefrom.

When processing is to be carried out sequentially from the lower-layer cleaning line to the upper-layer cleaning line, the wafer, which has undergone polishing, is transported into the cleaning processing chamber in the former side in the lower-layer cleaning line by the center transporting means. The transported wafer is subjected to required cleaning processes while the wafer is sequentially transported to the adjacent cleaning processing chambers by the inter-chamber transporting means, and the wafer is carried out from the cleaning processing chamber in the latter-side by the center transporting means. Then, the wafer is transported into the cleaning processing chamber in the former side in the upper-layer cleaning line by the center transporting means. The transported wafer is subjected to required cleaning processes while the wafer is sequentially transported to the adjacent cleaning processing chambers by the inter-layer transporting means, and the wafer is subjected to a drying process in the last cleaning processing chamber in the upper-layer cleaning line and carried out therefrom.

When processing is to be carried out in parallel in the lower-layer cleaning line and the upper-layer cleaning line, the wafer, which has undergone polishing, is transported into the cleaning processing chamber in the former side in the lower-layer cleaning line by the center transporting means, and the wafer is subjected to required cleaning processes and drying and carried out therefrom. Approximately in parallel with this process, another wafer, which has undergone polishing, is transported into the cleaning processing chamber in the former side in the upper-layer cleaning line by the center transporting means. In this manner, parallel processing of the wafers is carried out by simultaneously operating the lower-layer and upper-layer cleaning lines.

The invention according to claim 2 provides the cleaning apparatus wherein even when either one of the lower-layer or upper-layer cleaning lines is stopped, the other cleaning line can be operated.

According to this configuration, even when either one of the lower-layer or upper-layer cleaning lines is stopped for some reason, cleaning processes are carried out in the other cleaning line. Therefore, the cleaning processing function as the entire apparatus can be always maintained.

The invention according to claim 3 provides the cleaning apparatus, wherein each of the cleaning processing chambers in the lower-layer and upper-layer cleaning lines can be replaced by another cleaning processing chamber with approximately the same shape.

According to this configuration, the plurality of cleaning processing chambers in the lower-layer and upper-layer cleaning lines can be replaced or rearranged so that optimal cleaning processing functions can be obtained in accordance with the cleaning treatment process and the like of the wafer.

The invention according to claim 4 provides a cleaning apparatus comprising: cleaning lines comprised of lower and upper two levels, each of the levels comprising a plurality of cleaning processing chambers which subjects a wafer, which has undergone polishing, to a required cleaning process and drying; a center transporting means comprising a function of transporting a wafer to be processed into or transporting the processed wafer to each of the cleaning processing chambers in the lower-layer and upper-layer cleaning lines; an inter-chamber transporting means for sequentially transporting the wafer to the adjacent cleaning processing chamber in each of the lower-layer and upper-layer cleaning lines; and an introducing means for introducing pure water used in the cleaning processing chamber, which carries out precision cleaning in a latter side in the upper-layer cleaning line, into the cleaning processing chamber, which carries out rough cleaning in a former side in the lower-layer cleaning line, as washing water for the rough cleaning.

According to this configuration, when a series of processes from rough cleaning to precision cleaning is to be carried out merely in the lower-layer cleaning line, the wafer, which has undergone polishing such as chemical mechanical polishing, is transported into the cleaning processing chamber in the former side in the lower-layer cleaning line by the center transporting means. The transported wafer is subjected to required cleaning processes including rough cleaning while the wafer is sequentially transported to the adjacent cleaning processing chambers by the inter-chamber transporting means, and the wafer is subjected to precision cleaning and a drying process in the cleaning processing chamber in the latter side and carried out therefrom.

When a series of processes from rough cleaning to precision cleaning is to be carried out merely in the upper-layer cleaning line, the wafer, which has undergone polishing, is transported into the cleaning processing chamber, which carries out rough cleaning in the former side in the upper-layer cleaning line, by the center transporting means. The transported wafer is subjected to required cleaning processes including rough cleaning while the wafer is sequentially transported to the adjacent cleaning processing chamber by the inter-chamber transporting means, and the wafer is subjected to precision cleaning and a drying process in the cleaning chamber in the latter side and carried out therefrom.

When processing is to be carried out sequentially from the lower-layer cleaning line to the upper-layer cleaning line, the wafer, which has undergone polishing, is transported into the cleaning processing chamber, which carries out rough cleaning in the former side in the lower-layer cleaning line, by the center transporting means. The transported wafer is subjected to required cleaning processes including rough cleaning while the wafer is sequentially transported to the adjacent cleaning processing chambers by the inter-chamber transporting means, and the wafer is then carried out therefrom by the center transporting means. Then, the wafer is further transported into the cleaning processing chamber in the latter side in the upper-layer cleaning line by the center transporting means. The transported wafer is subjected to required cleaning processes including precision cleaning and a drying process while the wafer is sequentially transported to the adjacent cleaning processing chambers by the inter-chamber transporting means, and the wafer is carried out therefrom. In this course, the pure water used in precision cleaning in the cleaning processing chamber in the latter side in the upper-layer cleaning line is reutilized by being introduced into the cleaning processing chamber, which carries out rough cleaning in the former side in the lower-layer cleaning line as washing water for the rough cleaning.

When a series of processes from rough cleaning to precision cleaning is to be carried out in parallel respectively in the upper-layer cleaning line and the lower-layer cleaning line, the wafer, which has undergone polishing, is transported into the cleaning processing chamber, which carries out rough cleaning in the former side in the upper-layer cleaning line, by the center transporting means. The transported wafer is subjected to required cleaning processes including rough cleaning while the wafer is sequentially transported to the adjacent cleaning processing chambers by the inter-chamber transporting means, and the wafer is subjected to precision cleaning and a drying process in the cleaning processing chamber in the latter-side and carried out therefrom. Approximately in parallel with this process, another wafer, which has undergone polishing, is transported into the cleaning processing chamber, which carries out rough cleaning in the former side in the lower-layer cleaning line, by the center transporting means, and the wafer is subjected to rough cleaning utilizing the pure water used in precision cleaning in the cleaning processing chamber in the latter side in the upper-layer cleaning line as washing water and subjected to a required cleaning process. Then, the wafer is subjected to precision cleaning and a drying process in the cleaning processing chamber in the latter side while the wafer is sequentially transported to the adjacent cleaning processing chambers by the inter-chamber transporting means, and the wafer is carried out therefrom. As described above, while arbitrarily utilizing the pure water used in the precision cleaning in the upper-layer cleaning line as the washing water for rough cleaning in the lower-layer cleaning line, the parallel processing of the wafer is carried out by simultaneously operating the lower-layer and upper-layer cleaning lines.

The invention according to claim 5 provides the cleaning apparatus wherein the introducing means comprising a washing water retention chamber for temporarily retaining the pure water used in the cleaning processing chamber for carrying out precision cleaning, washing water piping connecting the washing water retention chamber to the cleaning processing chamber for carrying out the rough cleaning, and a regulating valve provided in the washing water piping for regulating supplying of the washing water to the cleaning processing chamber, which carries out the rough cleaning.

According to this configuration, the pure water used in the precision cleaning in the cleaning processing chamber in the latter side in the upper-layer cleaning line is once retained in the washing water retention chamber. When rough cleaning is to be carried out in the cleaning processing chamber in the former side in the lower-layer cleaning line, the water is introduced from the washing water retention chamber into the cleaning processing chamber for the rough cleaning as the washing water for the rough cleaning via the washing water piping while the supplying amount thereof is regulated to an appropriate amount by the regulating valve.

The invention according to claim 6 provides the cleaning apparatus, wherein the introduction of the washing water by the introducing means from the cleaning processing chamber, which carries out precision cleaning, to the cleaning processing chamber, which carries out the rough cleaning, is carried out by difference in the head of water between the upper-layer cleaning line and the lower-layer cleaning line.

According to this configuration, the pure water used in the precision cleaning in the cleaning processing chamber in the latter side in the upper-layer cleaning line is introduced into the cleaning processing chamber for rough cleaning in the lower-layer cleaning line as washing water by utilizing the difference in the head of water between the upper-layer cleaning line and the lower-layer cleaning line.

The invention according to claim 7 provides the cleaning apparatus wherein the cleaning processing chamber, which carries out precision cleaning in the latter side in the upper-layer cleaning line, is communicated with the cleaning processing chamber, which carries out the rough cleaning in the former side in the lower-layer cleaning line, by an air duct, and clean air supplied from a clean air supplying unit to the cleaning processing chamber, which carries out the precision cleaning, is sent to the cleaning processing chamber, which carries out the rough cleaning, via the air duct.

According to this configuration, the clean air supplied from the clean air supplying unit to the cleaning processing chamber, which carries out precision cleaning in the upper-layer cleaning line, is not just discharged, but is blown into the cleaning processing chamber, which carries out rough cleaning in the lower-layer cleaning line, via the air duct and is reutilized as the air for the clean ambient of the cleaning processing chamber, which carries out rough cleaning.

The invention according to claim 8 provides a cleaning apparatus, wherein the wafer, which has undergone polishing, is subjected to a required cleaning process including the rough cleaning in the cleaning processing chamber in the former side in the lower-layer cleaning line, and the wafer is then transported to the cleaning processing chamber in the latter side in the upper-layer cleaning line by the center transporting means and subjected to a required cleaning process including the precision cleaning and a drying process so as to subject the wafer to a series of required processes.

According to this configuration, rough cleaning with respect to the wafer, which has undergone polishing, is carried out in the cleaning processing chamber for rough cleaning in the lower-layer cleaning line, and the precision cleaning thereafter is carried out in the cleaning processing chamber for precision cleaning in the upper-layer cleaning line. Therefore, the pure water and clean air used in the cleaning processing chamber for precision cleaning can be effectively reutilized as the washing water and the air for the clean ambient in the cleaning processing chamber for the rough cleaning.

The invention according to claim 9 provides the cleaning apparatus, wherein at least each of the cleaning processing chambers in the upper-layer cleaning line is attached to an apparatus frame via an anti-vibration means.

According to this configuration, transmission of the vibration generated upon operation of at least the cleaning processing chambers in the upper-layer cleaning line to the other cleaning processing chambers, the transporting means, or the like can be suppressed.

The invention according to claim 10 provides the cleaning apparatus, wherein even when either one of the cleaning lines among the lower-layer or upper-layer cleaning lines is stopped, the other cleaning line can be operated.

According to this configuration, even when either one of the lower-layer or upper-layer cleaning lines is stopped for some reason, the cleaning processes from rough cleaning to precision cleaning is carried out in the other cleaning line. Therefore, the cleaning processing function as the entire apparatus is always maintained.

The invention according to claim 11 provides the cleaning apparatus, wherein each of the cleaning processing chambers in the lower-layer and upper-layer cleaning lines can be replaced by another cleaning processing chamber with an approximately the same shape.

According to this configuration, the plurality of cleaning processing chambers in the lower-layer and upper-layer cleaning lines can be replaced or rearranged so that optimal cleaning processing functions can be obtained in accordance with the cleaning treatment process and the like of the wafer.

The invention according to claim 1 is provided with cleaning lines comprised of lower and upper two levels, each of the levels comprising a plurality of cleaning processing chambers which subjects a wafer, which has undergone polishing, to a required cleaning process and drying; a center transporting means comprising a function of transporting the wafer, which has undergone polishing, into or transporting the processed wafer from each of the cleaning processing chambers in the lower-layer and upper-layer cleaning lines; and an inter-chamber transporting means for sequentially transporting the wafer to the adjacent cleaning processing chamber in each of the lower-layer and upper-layer cleaning lines. Therefore, any of the processing merely by the lower-layer cleaning line, processing merely by the upper-layer cleaning line, and successive processing from the lower-layer cleaning line to the upper-layer cleaning line can be carried out, and the wafer, which has undergone polishing, can be subjected to various cleaning processes. Moreover, parallel processing can be carried out in the lower-layer and upper-layer cleaning lines, the processing speed of the wafer per unit floor area can be increased, the operating rate can be significantly improved, and various wafers to be subjected to different cleaning processes can be simultaneously processed. Moreover, there are advantages that carry in/out of the wafers with respect to the lower-layer and upper-layer cleaning processing chambers can be directly carried out by the common center transporting means, and the apparatus configuration can be simplified.

In the invention according to claim 2, even when either one of the lower-layer or upper-layer cleaning lines is stopped, the other cleaning line can be operated. Therefore, there is an advantage that defects are not generated in the wafer in process of pre-treatment or the like since the cleaning processing function as the entire apparatus is always maintained.

In the invention according to claim 3, each of the cleaning processing chambers in the lower-layer and upper-layer cleaning lines can be replaced by another cleaning processing chamber with approximately the same shape. Therefore, there is an advantage that the plurality of cleaning processing chambers in the cleaning lines can be replaced or rearranged to an optimum arrangement.

The invention according to claim 4 is provided with cleaning lines comprised of lower and upper two levels, each of the levels comprising a plurality of cleaning processing chambers which subjects a wafer, which has undergone polishing, to a required cleaning process and drying; a center transporting means comprising a function of transporting a wafer to be processed into or transporting the processed wafer from each of the cleaning processing chambers in the lower-layer and upper-layer cleaning lines; an inter-chamber transporting means for sequentially transporting the wafer to the adjacent cleaning processing chamber in each of the lower-layer and upper-layer cleaning lines; and an introducing means for introducing pure water used in the cleaning processing chamber, which carries out precision cleaning in a latter side in the upper-layer cleaning line, into the cleaning processing chamber, which carries out rough cleaning in a former side in the lower-layer cleaning line, as washing water for the rough cleaning. Therefore, either the series of processes from rough cleaning to precision cleaning merely by the lower-layer cleaning line or merely by the upper-layer cleaning line or a successive process from rough cleaning to precision cleaning from the lower-layer cleaning line to the upper-layer cleaning line can be carried out, and the wafer, which has undergone polishing, can be subjected to various cleaning processes. Moreover, parallel processing from rough cleaning to precision cleaning in the lower-layer and upper-layer cleaning lines can be carried out, the processing speed of the wafer per unit floor area can be increased, the operating rate can be significantly improved, and various wafers to be subjected to different cleaning processes can be simultaneously processed. Moreover, in the above described processing modes, upon rough cleaning in the former side in the lower-layer cleaning line, the pure water used in the precision cleaning in the cleaning processing chamber in the latter side in the upper-layer cleaning line can be reutilized as the washing water for the rough cleaning, and the usage amount of pure water can be reduced. Furthermore, there are advantages that carry in/out of the wafers with respect to the cleaning processing chambers of the lower-layer and upper-layer can be directly carried out by the common center transporting means, and the apparatus configuration can be simplified.

In the invention according to claim 5, the introducing means comprising a washing water retention chamber for temporarily retaining the pure water used in the cleaning processing chamber for carrying out precision cleaning, washing water piping connecting the washing water retention chamber to the cleaning processing chamber for carrying out the rough cleaning, and a regulating valve provided in the washing water piping for regulating supplying of the washing water to the cleaning processing chamber, which carries out the rough cleaning. Therefore, the pure water used in the precision cleaning in the upper-layer cleaning line is once retained in the washing water retention chamber, and, when rough cleaning is to be carried out in the cleaning processing chamber in the lower-layer cleaning line, the pure water retained in the washing water retention chamber can be introduced into the cleaning processing chamber for the rough cleaning while the supplying amount thereof is regulated to an appropriate amount by the regulating valve. Thus, there are advantages that the usage amount of pure water can be reduced, and the rough cleaning with respect to the wafer, which has undergone polishing, can be appropriately carried out.

In the invention according to claim 6, the introduction of the washing water by the introducing means from the cleaning processing chamber, which carries out precision cleaning, to the cleaning processing chamber, which carries out the rough cleaning, is carried out by difference in the head of water between the upper-layer cleaning line and the lower-layer cleaning line. Therefore, there are advantages that the pure water used in precision cleaning in the upper-layer cleaning line can be reutilized by introducing the water to the cleaning processing chamber for rough cleaning in the lower-layer cleaning line without using a pump or the like and the usage amount of pure water can be reduced while simplifying the apparatus configuration.

The invention according to claim 7 is configured so that the cleaning processing chamber, which carries out precision cleaning in the latter side in the upper-layer cleaning line, is communicated with the cleaning processing chamber, which carries out the rough cleaning in the former side in the lower-layer cleaning line, by an air duct, and clean air supplied from a clean air supplying unit to the cleaning processing chamber, which carries out the precision cleaning, is sent to the cleaning processing chamber, which carries out the rough cleaning, via the air duct. Therefore, the clean air supplied to the cleaning processing chamber, which carries out precision cleaning in the upper-layer cleaning line, can be reutilized as the air for the clean ambient of the cleaning processing chamber, which carries out rough cleaning in the lower-layer cleaning line. Thus, there is an advantage that the cost of the clean air supplying equipment can be reduced.

The invention according to claim 8 is configured so that the wafer, which has undergone polishing, is subjected to a required cleaning process including the rough cleaning in the cleaning processing chamber in the former side in the lower-layer cleaning line, and the wafer is then transported to the cleaning processing chamber in the latter side in the upper-layer cleaning line by the center transporting means and subjected to a required cleaning process including the precision cleaning and a drying process so as to subject the wafer to a series of required processes. Therefore, there is an advantage that the pure water and clean air used in the cleaning processing chamber for precision cleaning in the upper-layer cleaning line can be effectively reutilized as the washing water and the air for the clean ambient in the cleaning processing chamber for rough cleaning in the lower-layer cleaning line.

In the invention according to claim 9, at least each of the cleaning processing chambers in the upper-layer cleaning line is attached to an apparatus frame via an anti-vibration means. Therefore, there are advantages that transmission of the vibration generated upon operation of at least each of the cleaning processing chambers in the upper-layer cleaning line to the other cleaning processing chambers, the transporting means, or the like can be suppressed, and always stable cleaning performance and transport of the wafer can be carried out.

In the invention according to claim 10, even when either one of the cleaning lines among the lower-layer or upper-layer cleaning lines is stopped, the other cleaning line can be operated. Therefore, there is an advantage that defects are not generated in the wafers in process of, for example, pretreatment or the like since the cleaning processing function as the entire apparatus can be always maintained.

In the invention according to claim 11, each of the cleaning processing chambers in the lower-layer and upper-layer cleaning lines can be replaced by another cleaning processing chamber with an approximately the same shape. Therefore, there is an advantage that the plurality of cleaning processing chambers in the cleaning lines can be replaced or rearranged to an optimal arrangement in accordance with the cleaning treatment process and the like of the wafers.

### BRIEF DESCRIPTION OF THE DRAWINGS

FIGS. 1A and 1B are drawings showing a cleaning apparatus according to the invention of claims 1 to 3, wherein (a) is a plan view and (b) is a side view.

FIGS. 2A and 2B are drawings showing a cleaning apparatus according to the invention of claims 4 to 11, wherein (a) is a plan view and (b) is a side view.

FIG. 3 is a configuration diagram showing an introducing means for introducing washing water to a cleaning processing chamber that carries out rough cleaning and an air duct for supplying clean air.

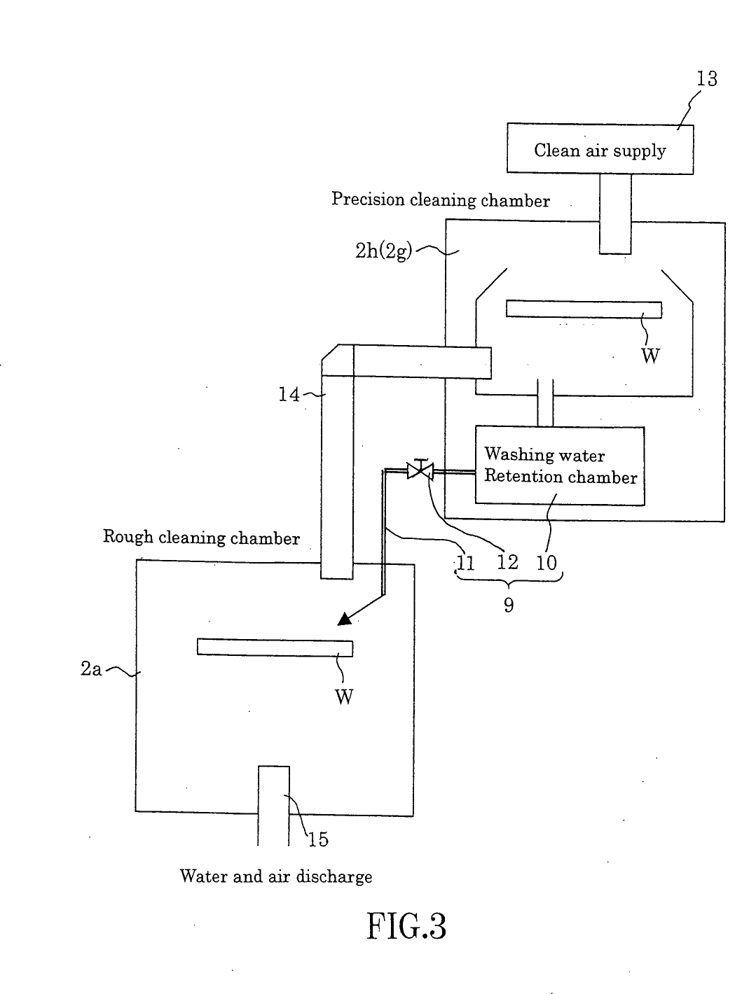

### DETAILED DESCRIPTION OF THE PREFERRED EMBODIMENTS

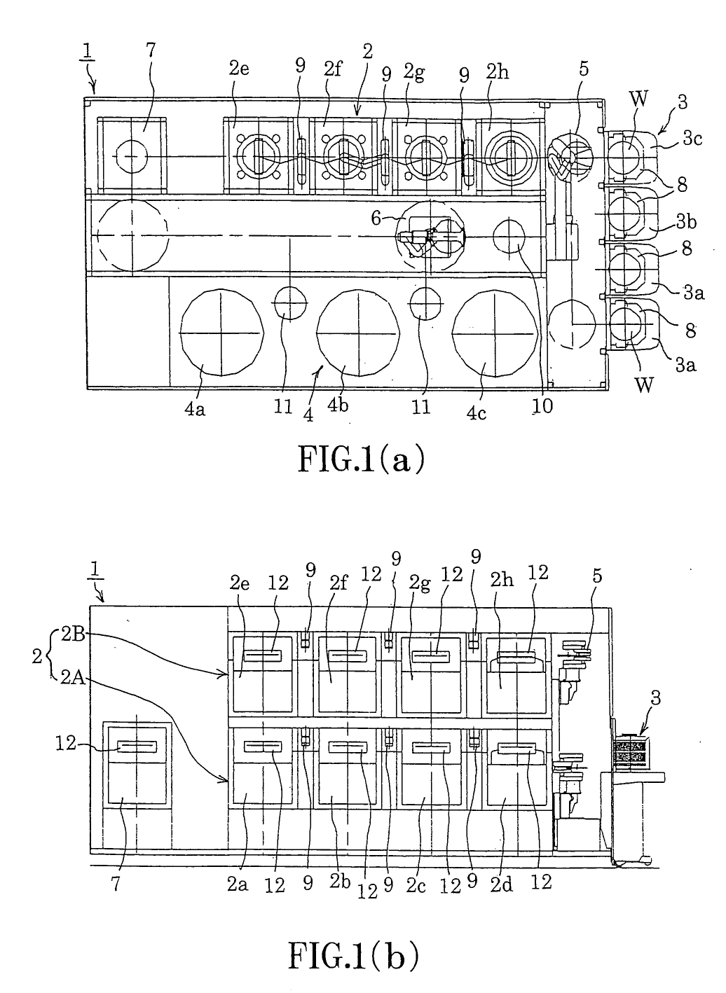

First of all, a preferred embodiment of the present invention according to claims 1 to 3 of the present invention will be described with reference to a drawing. FIGS. 1A and 1B are drawings showing a cleaning apparatus, wherein (a) is a plan view and (b) is a side view.

The configuration of the cleaning apparatus according to the present embodiment will be described first. In FIG. 1, the cleaning apparatus 2 is disposed in a chemical mechanical polishing apparatus 1. The chemical mechanical polishing apparatus 1 mainly comprises, other than the cleaning apparatus 2, a load port unit 3, a polishing apparatus 4, a first, transporting machine 5, a center transporting machine 6 serving as a center transporting means, an option chamber 7, and an apparatus control unit (not shown).

The load port unit 3 comprises product wafer load ports 3a and 3a, a dummy wafer load port 3b, and a monitor wafer load port 3c. A cassette 8 storing in which a plurality of wafers W are stored is placed in each of the load ports 3a, 3b, and 3c.

The polishing apparatus 4 is mainly comprises three platens 4a, 4b, and 4c arranged in a part in one side of the chemical mechanical polishing apparatus 1 and two polishing heads (not shown) which are movably provided in the arrangement direction of the three platens 4a, 4b, and 4c. Each of the platens 4a, 4b, and 4c is formed to have a disk-like shape and rotates in one direction when it is driven by a motor (not shown). A polishing pad is attached on the upper surface of each of the platens 4a, 4b, and 4c, and slurry is supplied onto the polishing pad from a nozzle (not shown).

Among the three platens 4a, 4b, and 4c, the left and right platens 4a and 4c are used in polishing of a first polishing target film (for example, Cu film), and the center platen 4b is used in polishing of a second polishing target film (for example, Ta film). In polishing of both of them, the type of supplied slurry, the rotating speed of the polishing heads, the rotating speed of the platens 4a, 4b, and 4c, the thrust force of the polishing head, the material of the polishing pads, or the like are changed.

In the polishing apparatus 4, the wafers W are retained by the polishing heads, the wafers are brought into contact with the polishing pads with a pressure while supplying the slurry from the nozzles to the polishing pads, and chemical mechanical polishing of the wafers W are carried out in this state by rotating the platens 4a, 4b, and 4c and the polishing heads.

The cleaning apparatus 2 is disposed in the other side of the chemical mechanical polishing apparatus 1 so that the cleaning apparatus is opposed to the polishing apparatus 4. The cleaning apparatus 2 comprises two levels including a lower-layer cleaning line 2A comprising four cleaning processing chambers 2a to 2d and an upper-layer cleaning line 2B similarly comprising four cleaning processing chambers 2e to 2h.

The four cleaning processing chambers 2a to 2d in the lower-layer cleaning line 2A comprises: for example, the cleaning processing chamber 2a which cleans the wafer W by rubbing the first surface and the second surface of the wafer by sponge brushes, the cleaning processing chamber 2b which cleans the wafer W by causing steam to be jetted onto the first surface and the second surface of the wafer, the cleaning processing chamber 2c which cleans the wafer W by ultrasonic waves, and the cleaning processing chamber 2d which removes remaining dust by subjecting the first surface of the wafer W to an etching process of as light degree, then subjects the wafer to rinse cleaning, and subjects the wafer to spin drying at last.

The four cleaning processing chambers 2e to 2h in the upper-layer cleaning line 2B are configured in the manner approximately same as the four cleaning processing chambers 2a to 2d in the lower-layer cleaning line 2A.

Note that the cleaning processing chambers 2a to 2h in the lower-layer and upper-layer cleaning lines 2A and 2B can be replaced or rearranged by cleaning processing chambers with approximately the same outer shapes and different cleaning processing functions. The lower-layer and upper-layer cleaning lines 2A and 2B are configured so that at least either one of them is always operated.

Inter-chamber transporting machines 9 serving as inter-chamber transporting means are disposed between the cleaning processing chambers 2a to 2h in the lower-layer and upper-layer cleaning lines 2A and 2B respectively. The inter-chamber transporting machine 9 sequentially transports the wafer W to adjacent cleaning processing chambers (for example, 2a and 2b).

The first transporting machine 5 picks up the unpolished wafer W from the cassette 8 placed in the product wafer load port 3a, 3a and transports the wafer to a wafer standby position 10. Also, the first transporting machine 5 directly receives the wafer W, which has undergone cleaning processes in the lower-layer or upper-layer cleaning line 2A or 2B, from the last cleaning processing chamber 2d or 2h thereof and transports the wafer into the product wafer load port 3a and 3a.

The center transporting machine 6 receives the unpolished wafer W from the wafer standby position 10 and transports the wafer into the polishing apparatus 4 via a passing position 11. The transporting machine also receives the wafer W, which has undergone polishing, via the passing position 11 and transports the wafer to each of the cleaning processing chambers 2a to 2h of the lower-layer and upper-layer cleaning lines 2A and 2B. The center transporting machine 6 comprises a function of directly carrying in/out into or from any of the cleaning processing chambers 2a to 2h of the lower-layer and upper-layer cleaning lines 2A and 2B. Therefore, a front transporting opening 12 for carrying in/out the wafer W is provided in each of the cleaning processing chambers 2a to 2h of the lower-layer and upper-layer cleaning lines 2A and 2B.

The option chamber 7 comprising functions of subjecting the wafer W, which has not undergone polishing, has undergone polishing, or has undergone a cleaning process, to a predetermined process, film-thickness measurement, or the like in addition to the above described polishing and cleaning process, then passing the wafer W to the center transporting machine 6, and transporting the wafer to a required next process via the center transporting machine 6. The front transporting opening 12 for carrying in/out the wafer W is also provided in the option chamber 7.

The working of the cleaning apparatus, which is configured in the above described manner, will next be described. In the cleaning apparatus of the present embodiment, the cleaning lines 2A and 2B are configured to have two levels of the lower-layer and the upper-layer; therefore, various cleaning processing modes such as (a) carrying out a series of cleaning processes merely by the lower-layer cleaning line 2A, (b) carrying out a series of cleaning processes merely by the upper-layer cleaning line 2B, (c) carrying out cleaning processes sequentially from the lower-layer cleaning line 2A to the upper-layer cleaning line 2B, and (d) carrying out cleaning processes in parallel in the lower-layer cleaning line 2A and the upper-layer cleaning line 2B can be employed. Hereinafter, these modes will be sequentially described.

(a) This is the case in which a series of cleaning processes is carried out merely in the lower-layer cleaning line 2A. In this case, the wafer W, which has undergone chemical mechanical polishing in the polishing apparatus 4, is received by the center transporting machine 6 via the passing position 11 and transported to the cleaning processing chamber 2a which is in the start-point side in the lower-layer cleaning line 2A. The transported wafer W is subjected to required cleaning processes while the wafer is sequentially transported to the adjacent cleaning chambers 2b, 2c, and 2d by the inter-chamber transporting machines 9, and a drying process is carried out in the last cleaning processing chamber 2d to finish the cleaning process.

After the cleaning process is finished, the wafer W is directly passed from the last cleaning processing chamber 2d to the first transporting machine 5 and transported to the product wafer load port 3a and 3a.

(b) This is the case in which a series of cleaning processes are carried out merely in the upper-layer cleaning line 2B. In this case, the wafer W, which has undergone chemical mechanical polishing, is directly transported to the cleaning processing chamber 2e which is in the start-point side of the upper-layer cleaning line 2B by the center transporting machine 6. The transported wafer W is subjected to required cleaning processes while the wafer is sequentially transported to the adjacent cleaning processing chambers 2f, 2g, and 2h by the inter-chamber transporting machines 9, and a drying process is carried out in the last cleaning processing chamber 2h to finish the cleaning process.

After the cleaning process is finished, the wafer W is directly passed from the last cleaning processing chamber 2h to the first transporting machine 5 and transported to the product wafer load port 3a and 3a.

(c) This is the case in which cleaning processes are sequentially carried out from the lower-layer cleaning line 2A to the upper-layer cleaning line 2B. In this case, first, the wafer W, which has undergone chemical mechanical polishing, is transported to the cleaning processing chamber 2a in the start-point side of the lower-layer cleaning line 2A by the center transporting machine 6. The transported wafer W is subjected to required cleaning processes while the wafer is sequentially transported to the adjacent cleaning processing chambers 2b, 2c, and 2d by the inter-chamber transporting machines 9.

Then, at any of the points when a cleaning process is carried out merely by the cleaning processing chamber 2a in the start-point side, when cleaning processes are carried out by the two cleaning processing chambers 2a and 2b, when cleaning processes are carried out by the three cleaning processing chambers 2a, 2b, and 2c, or when cleaning processes are carried out until the last cleaning processing chamber 2d, the wafer W is transported from the corresponding cleaning processing chamber 2a, 2b, 2c, or 2d by the center transporting machine 6. Then, the wafer is transported to the cleaning processing chamber 2 in the start-point side of the upper-layer cleaning line 2B by the center transporting machine 6.

The wafer W transported to the upper-layer cleaning line 2B is subjected to required cleaning processes while the wafer is sequentially transported to the adjacent cleaning processing chambers 2f, 2g, and 2h by the inter-chamber transporting machines 9, and the wafer is subjected to a drying process in the last cleaning processing chamber 2h, thereby finishing the cleaning processes from the lower-layer cleaning line 2A to the upper-layer cleaning line 2B.

After the cleaning processes are finished, the wafer W is passed from the last cleaning processing chamber 2h of the upper-layer cleaning line 2B to the first transporting machine 5 and transported to the product wafer load port 3a and 3a.

(d) This is the case in which cleaning processes are carried out in parallel in the lower-layer cleaning line 2A and the upper-layer cleaning line 2B. In this case, the wafer W, which has undergone chemical mechanical polishing, is transported to the start-point side cleaning processing chamber 2a of the lower-layer cleaning line 2A by the center transporting machine 6. The transported wafer W is subjected to required cleaning processes while the wafer is sequentially transported to the adjacent cleaning processing chambers 2b, 2c, and 2d by the inter-chamber transporting machines 9. The cleaning-process-finished wafer W is passed from the last cleaning processing chamber 2d to the first transporting machine 5 and transported to the product wafer port 3a and 3a.

Approximately in parallel with this process, another wafer W, which has undergone chemical mechanical polishing, is transported to the cleaning processing chamber 2e in the start-point side of the upper-layer cleaning line 2B by the center transporting machine 6. The transported wafer W is subjected to required cleaning processes while the wafer is sequentially transported to the adjacent cleaning processing chambers 2f, 2g, and 2h by the inter-chamber transporting machines 9. The cleaning-process-finished wafer W is passed from the last cleaning processing chamber 2h to the first transporting machine 5 and transported to the product wafer load port 3a and 3a. In this manner, the parallel processing of the wafers W is carried out by simultaneously operating the lower-layer and upper-layer cleaning lines 2A and 2B.

As described above, the cleaning processing chambers 2a to 2d of the lower-layer cleaning line 2A and the cleaning processing chambers 2e to 2h of the upper-layer cleaning line 2B are comprised of those approximately the same cleaning processing functions. The lower-layer and upper-layer cleaning lines 2A and 2B are configured so that at least either one of them is always operated.

Therefore, in the case in which cleaning processes are carried out merely in the lower-layer cleaning line 2A or the upper-layer cleaning line 2B, when either one of the cleaning lines is stopped for some reasons, required cleaning processes can be carried out without causing any troubles by switching execution of the cleaning processes to the other cleaning line.

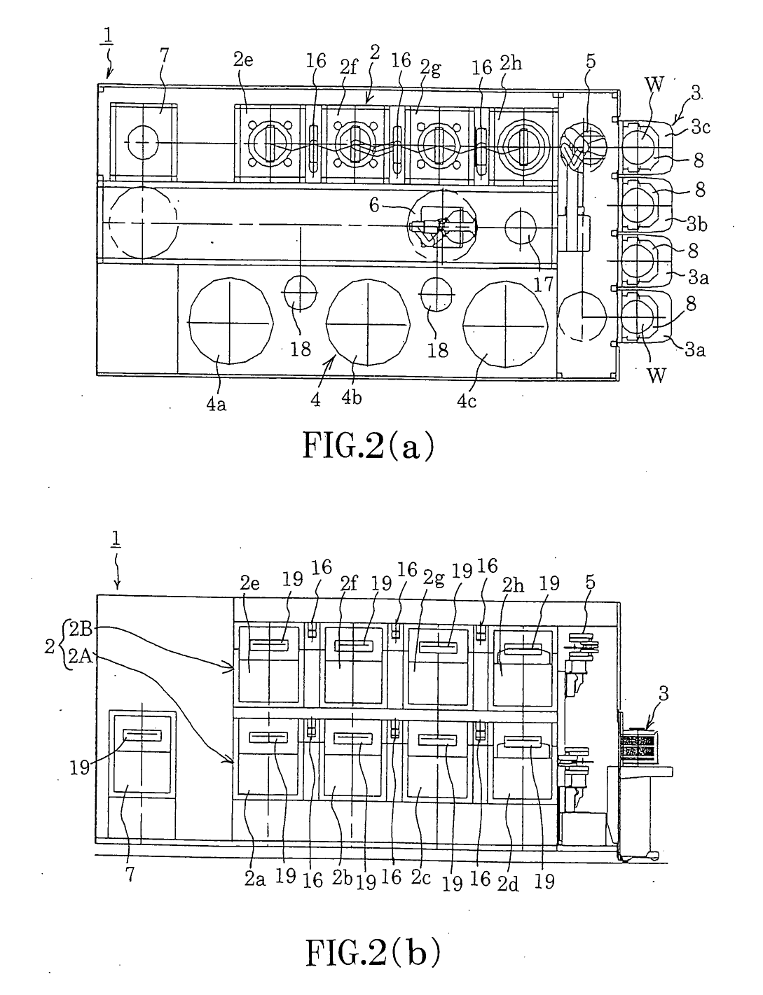

A preferred embodiment of the invention according to claims 4 to 11 of the present invention will next be described in detail with reference to drawings. FIGS. 2A and 2B show drawings showing a cleaning apparatus of the invention according to claims 4 to 11, wherein (a) is a plan view and (b) is a side view. FIG. 2 is a configuration diagram showing an introducing means for introducing washing water to the cleaning processing chamber which carries out rough cleaning in the lower-layer cleaning line and an air duct for supplying clean air.

The configurations common with the configurations described for the invention according to claims 1 to 3 based on FIGS. 1A and 1B are denoted by the same reference numerals, and redundant descriptions thereof will be omitted.

In the invention according to claims 4 toll, the plurality of cleaning processing chambers 2a to 2d and 2e to 2h are comprised of two levels, the lower-layer cleaning line 2A and the upper-layer cleaning line 2B. Therefore, the vibration generated upon operation of each of the cleaning processing chambers 2e to 2h in the upper-layer cleaning line 2B is readily transmitted to other cleaning processing chambers, the transporting means, or the like. Therefore, at least each of the cleaning processing chambers 2e to 2h of the upper-layer cleaning line 2B is disposed on an apparatus frame via anti-vibration rubber (not shown) or the like serving as an anti-vibration means. As a result, transmission of the vibration generated upon operation of at least the cleaning processing chambers 2e to 2h of the upper-layer cleaning line 2B to the other cleaning processing chambers, transporting means, or the like can be suppressed.

The four cleaning processing chambers 2a to 2d in the lower-layer cleaning line 2A comprises: for example, the cleaning processing chamber 2a which causes a required processing liquid to drip, rubs the first surface and the second surface of the wafer by sponge brushes, and then supplies pure water to the first and second surfaces of the wafer W so as to wash away particles and the like that have got away from the wafer W; the cleaning processing chamber 2b which cleans the wafer W by causing steam to be jetted onto the first surface and the second surface of the wafer; the cleaning processing chamber 2c which cleans the wafer W by pure water excited by ultrasonic waves; and the cleaning processing chamber 2d which removes remaining dust by subjecting the first surface of the wafer W to an etching process of a slight degree by chemical solutions, then subjects the wafer to rinse cleaning, and subjects the wafer to spin drying at last. As described above, the cleaning line 2A is comprised of the cleaning processing chambers 2a to 2d which carry out a series of processes of the cleaning processing chamber 2a which carries out so-called rough cleaning to the cleaning processing chambers 2c and 2d which carry out precision cleaning.

In approximately the same manner as the four cleaning processing chambers 2a to 2d in the lower-layer cleaning line 2A, the four cleaning processing chambers 2e to 2h in the above described upper-layer cleaning line 2B are also comprised of the cleaning processing chambers 2e to 2h which carry out a series of processes of the cleaning processing chamber 2e which carries out rough cleaning to the cleaning processing chambers 2g and 2h which carry out precision cleaning.

The rough cleaning herein for cleaning the wafer W on which slurry or the like is adhering immediately after CMP polishing does not require highly purified pure water. Therefore, in the present embodiment, the large amount of pure water used for rinsing upon precision cleaning in the cleaning processing chambers 2g and 2h in the upper-layer cleaning line 2B is not just wasted but is reutilized as washing water for carrying out rough cleaning for washing away particles, dispersed chemical solutions, or the like in the cleaning processing chamber 2a of the lower-layer cleaning line 2A.

Also, in the cleaning processing chamber 2a which carries out rough cleaning, the air for clean ambient does not require highly purified air. Therefore, in the present embodiment, the clean air processed by a HEPA filter (super-performance filter) or the like and supplied to the cleaning processing chambers 2g and 2h which carry out precision cleaning in the upper-layer cleaning line 2B is not just discharged, but is blown into the cleaning processing chamber 2a, which carries out rough cleaning in the lower-layer cleaning line 2A, via the air duct and reutilized as air for the clean ambient of the cleaning processing chamber 2a.

FIGS. 2A and 2B show the introducing means 9 for introducing washing water from the cleaning processing chamber 2h (2g), which carries out precision cleaning in the upper-layer cleaning line 2B, to the cleaning processing chamber 2a, which carries out rough cleaning in the lower-layer cleaning line 2A, and the air duct 14 for supplying clean air. The introducing means 9 comprises: a washing water retention chamber 10, which temporarily retains pure water used in the cleaning processing chamber 2h (2g), which carries out precision cleaning in the upper-layer cleaning line 2B; washing water piping 11 connecting the washing water retention chamber 10 to the cleaning processing chamber 2a, which carries out rough cleaning in the lower-layer cleaning line 2A; and a regulating valve 12, which is provided in the clean water piping 11 and regulates supply of washing water to the cleaning processing chamber 2a which carries out the rough cleaning.

Then, the pure water used in precision cleaning in the cleaning processing chamber 2h (2g) in the latter side in the upper-layer cleaning line 2B is once retained in the washing water retention chamber 10 and supplied to the cleaning processing chamber 2a for rough cleaning in the lower-layer cleaning line 2A as washing water for the rough cleaning by utilizing the difference between the heads of water between the upper-layer cleaning line 2B and the lower-layer cleaning line 2A without using a pump or the like. In this course, the supplying amount thereof is appropriately regulated by the regulating valve 12, thereby saving the usage amount of pure water and appropriately carrying out rough cleaning with respect to the wafer W after polishing.

The cleaning processing chamber 2h (2g), which carries out precision cleaning in the latter side in the upper-layer cleaning line 2B, and the cleaning processing chamber 2a, which carries out rough cleaning in the former side in the lower-layer cleaning line 2A, are communicated by the air duct 14. The clean air processed by a HEPA filter or the like in a clean air supplying unit 13 and supplied to the cleaning processing chamber 2g and 2h, which carries out precision cleaning in the upper-layer cleaning line 2B, is sent to the cleaning processing chamber 2a, which carries out rough cleaning in the lower-layer cleaning line 2A, via the air duct 14 and is reutilized as the air for the clean environment of the cleaning processing chamber 2a.

The washing water for rough cleaning and the air for the cleaning ambient introduced into the cleaning processing chamber 2a for rough cleaning is discharged to outside from a water/air discharge outlet 15 provided in the bottom of the cleaning processing chamber 2a.

Note that the cleaning processing chambers 2a to 2h in the lower-layer and upper-layer cleaning lines 2A and 2B can be replaced or rearranged by cleaning processing chambers with approximately the same outer shapes and different cleaning processing functions. The lower-layer and upper-layer cleaning lines 2A and 2B are configured so that at least either one of them is always operated.

Inter-chamber transporting machines 16 serving as inter-chamber transporting means are disposed between the cleaning processing chambers 2a to 2h in the lower-layer and upper-layer cleaning lines 2A and 2B respectively. The inter-chamber transporting machine 16 sequentially transports the wafer W to adjacent cleaning processing chambers (for example, 2a and 2b).

The first transporting machine 5 picks up the unpolished wafer W from the cassette 8 placed in the product wafer load port 3a, 3a and transports the wafer to a wafer standby position 17. Also, the first transporting machine 5 directly receives the wafer W, which has undergone cleaning processes in the lower-layer or upper-layer cleaning line 2A and 2B, from the last cleaning processing chamber 2d or 2h thereof and transports the wafer into the product wafer load port 3a and 3a.

The center transporting machine 6 receives the unpolished wafer W from the wafer standby position 17 and transports the wafer into the polishing apparatus 4 via a passing position 18. The transporting machine also receives the wafer W, which has undergone polishing, via the passing position 18 and transports the wafer to each of the cleaning processing chambers 2a to 2h of the lower-layer and upper-layer cleaning lines 2A and 2B. The center transporting machine 6 comprises a function of directly carrying in/out into or from any of the cleaning processing chambers 2a to 2h of the lower-layer and upper-layer cleaning lines 2A and 2B. Therefore, a front transporting opening 19 for carrying in/out the wafer W is provided in each of the cleaning processing chambers 2a to 2h of the lower-layer and upper-layer cleaning lines 2A and 2B.

The option chamber 7 comprises functions of subjecting the wafer W, which has not undergone polishing, has undergone polishing, or has undergone a cleaning process, to a predetermined process, film-thickness measurement, or the like in addition to the above described polishing and cleaning process, then passing the wafer W to the center transporting machine 6, and transporting the wafer to a required next process via the center transporting machine 6. The front transporting opening 19 for carrying in/out the wafer W is also provided in the option chamber 7.

The working of the cleaning apparatus, which is configured in the above described manner, will next be described. In the cleaning apparatus of the present embodiment, the cleaning lines 2A and 2B are configured to have two levels of the lower-layer and the upper-layer; therefore, various cleaning processing modes such as (a) carrying out a series of cleaning processes from rough cleaning to precision cleaning merely by the lower-layer cleaning line 2A, (b) carrying out a series of cleaning processes from rough cleaning to precision cleaning merely by the upper-layer cleaning line 2B, (c) carrying out cleaning processes from rough cleaning to precision cleaning sequentially from the lower-layer cleaning line 2A to the upper-layer cleaning line 2B, and (d) carrying out a series of cleaning processes in parallel from rough cleaning to precision cleaning respectively in the upper-layer cleaning line 2B and the lower-layer cleaning line 2A can be employed. Hereinafter, these modes will be sequentially described.

(a) This is the case in which a series of cleaning processes from rough cleaning to precision cleaning is carried out merely in the lower-layer cleaning line 2A. In this case, the wafer W, which has undergone chemical mechanical polishing in the polishing apparatus 4, is received by the center transporting machine 6 via the passing position 18 and transported to the cleaning processing chamber 2a, which is in the starting-end side in the lower-layer cleaning line 2A and carries out rough cleaning. The transported wafer W is subjected to required cleaning processes including rough cleaning while the wafer is transported to the adjacent cleaning chamber 2b by the inter-chamber transporting machine 16, precision cleaning and a drying process is carried out in cleaning processing chambers 2c and 2d in the latter-side, and the cleaning process is finished. After the cleaning process is finished, the wafer W is directly passed from the last cleaning processing chamber 2d to the first transporting machine 5 and transported into the product wafer load port 3a or 3a.

(b) This is the case in which a series of cleaning processes from rough cleaning to precision cleaning are carried out merely in the upper-layer cleaning line 2B. In this case, the wafer W, which has undergone chemical mechanical polishing, is directly transported to the cleaning processing chamber 2e, which is in the starting-end side of the upper-layer cleaning line 2B and carries out rough cleaning, by the center transporting machine 6. The transported wafer W is subjected to required cleaning processes while the wafer is transported to the adjacent cleaning processing chamber 2f by the inter-chamber transporting machine 16, the wafer is subjected to precision cleaning and a drying process in the latter-side cleaning processing chambers 2g and 2h, and the cleaning process is finished. In this process, since each of the cleaning processing chambers 2e to 2h in the upper-layer cleaning line 2B is disposed on the apparatus frame via anti-vibration rubber or the like serving as an anti-vibration means, transmission of the vibration that is generated upon operation of each of the cleaning processing chambers 2e to 2h to the transporting machines 5, 6, 16, or the like can be suppressed, and stable transporting of the wafer W can be carried out. After the cleaning process is finished, the wafer W is directly passed from the last cleaning processing chamber 2h to the first transporting machine 5 and transported to the product wafer load port 3a or 3a.

(c) This is the case in which cleaning processes from rough cleaning to precision cleaning are sequentially carried out from the lower-layer cleaning line 2A to the upper-layer cleaning line 2B. In this case, first, the wafer W, which has undergone chemical mechanical polishing, is transported to the cleaning processing chamber 2a in the starting-end side of the lower-layer cleaning line 2A by the center transporting machine 6. The transported wafer W is subjected to required cleaning processes including rough cleaning while the wafer is transported to the adjacent cleaning processing chamber 2b by the inter-chamber transporting machines 16. Then, at the point when required cleaning processes including rough cleaning are carried out in the two cleaning processing chambers 2a and 2b in the lower-layer cleaning line 2A, the wafer W is carried out by the center transporting machine 6 and subsequently transported into the cleaning processing chamber 2g in the latter side in the upper-layer cleaning line 2B by the center transporting machine 6. The transported wafer W is subjected to a required cleaning process including precision cleaning while the wafer is transported to the adjacent cleaning processing chamber 2h by the inter-chamber transporting machine 16, a drying process is carried out in the last cleaning processing chamber 2h, and the cleaning process from rough cleaning to precision cleaning from the lower-layer cleaning line 2A to the upper-layer cleaning line 2B is finished.

In this process, the pure water and clean air used in the cleaning processing chambers 2g and 2h, which carries out precision cleaning in the latter side in the upper-layer cleaning line 2B, is introduced into the cleaning processing chamber 2a as the washing water and the air for clean ambient of the cleaning processing chamber 2a, which carries out rough cleaning in the lower-layer cleaning line 2A, and effectively reutilized. Also, in the manner similar to that described above, transmission of the vibration generated upon operation of the cleaning processing chambers 2g and 2h in the upper-layer cleaning line 2B to the cleaning processing chambers 2a and 2b in the lower-layer cleaning line 2A and the transporting machines 5, 6, 16, or the like can be suppressed, thereby providing stable cleaning performance and transport of the wafer W. When the cleaning process from rough cleaning to precision cleaning is finished, the wafer W is passed from the last cleaning processing chamber 2h in the upper-layer cleaning line 2B to the first transporting machine 5 and transported to the product wafer load port 3a, 3a.

(d) This is the case in which a series of cleaning processes from rough cleaning to precision cleaning is carried out in parallel respectively in the upper-layer cleaning line 2B and the lower-layer cleaning line 2A. In this case, the wafer W, which has undergone chemical mechanical polishing, is transported to the starting-end side cleaning processing chamber 2e, which carries out rough cleaning in the upper-layer cleaning line 2B, by the center transporting machine 6. The transported wafer W is subjected to required cleaning processes including rough cleaning while the wafer is transported to the adjacent cleaning processing chamber 2f by the inter-chamber transporting machine 16, precision cleaning and a drying process is carried out in the latter-side cleaning processing chambers 2g and 2h, and the cleaning process is finished. The cleaning-process-finished wafer W is passed from the last cleaning processing chamber 2h to the first transporting machine 5 and transported to the product wafer port 3a, 3a.

Approximately in parallel with this process, another wafer W, which has undergone chemical mechanical polishing, is transported to the cleaning processing chamber 2a, which carries out rough cleaning in the starting-end side of the lower-layer cleaning line 2A, by the center transporting machine 6. The transported wafer W is subjected to required cleaning processes including rough cleaning while the wafer is transported to the adjacent cleaning processing chamber 2b by the inter-chamber transporting machine 9, precision cleaning and a drying process is carried out in the latter-side cleaning processing chambers 2c and 2d, and the cleaning process is finished. The cleaning-process-finished wafer W is passed from the last cleaning processing chamber 2d to the first transporting machine 5 and transported to the product wafer load port 3a and 3a. In this process, the pure water and clean air used in the cleaning processing chambers 2g and 2h, which carries out precision cleaning in the latter side in the upper-layer cleaning line 2B, is reutilized by being introduced into the cleaning processing chamber 2a as the washing water and air for the clean ambient of the cleaning processing chamber 2a, which carries out rough cleaning in the lower-layer cleaning line 2A. Also, in the manner described above, transmission of the vibration generated upon operation of each of the cleaning processing chambers 2e to 2h in the upper-layer cleaning line 2B to each of the cleaning processing chambers 2a to 2d in the lower-layer cleaning line 2A and each of the transporting machines 5, 6, 16, or the like can be suppressed, thereby realizing stable cleaning performance and transport of the wafer W. In this manner, the parallel processing of the wafer W is carried out by simultaneously operating each of the upper-layer and lower-layer cleaning lines 2A and 2B while arbitrarily reutilizing the pure water and clean air used in the precision cleaning in the upper-layer cleaning line 2B as the washing water for rough cleaning and air for the purified ambient in the lower-layer cleaning line 2A.

As described above, each of the cleaning processing chambers 2a to 2d in the lower-layer cleaning line 2A and the cleaning processing chambers 2e to 2h of the upper-layer cleaning line 2B are comprised of those approximately the same cleaning processing functions. The lower-layer and upper-layer cleaning lines 2A and 2B are configured so that at least either one of them is always operated. Therefore, in the case in which cleaning processes are carried out merely in the lower-layer cleaning line 2A or merely in the upper-layer cleaning line 2B, when either one of the cleaning lines is stopped for some reason, a required cleaning process can be carried out without any problem by switching execution of the cleaning process to the other cleaning line.

Each of the cleaning processing chambers 2a to 2d and 2e to 2h in the lower-layer and upper-layer cleaning lines 2A and 2B can be rearranged or replaced by cleaning processing chambers with approximately the same outer shapes and different cleaning processing functions. Therefore, when each of the cleaning processing chambers 2a to 2d and 2e to 2h are replaced or rearranged, the cleaning processing functions of each of the cleaning lines 2A or 2B can be arbitrarily changed.

As described above, in the cleaning apparatus according to the present embodiment, the wafer W, which has undergone chemical mechanical polishing, can be subjected to various cleaning processes, for example, successive processes can be carried out from the lower-layer cleaning line 2A to the upper-layer cleaning line 2B.

Parallel processing can be carried out in the lower-layer and upper-layer cleaning lines 2A and 2B, the processing speed of the wafer W per unit floor area can be increased, and the operating rate can be significantly improved.

Various wafers W to be subjected to different cleaning processes can be processed at the same time.

Carry in/out of the wafer W with respect to each of the cleaning processing chambers 2a to 2d and 2e and 2h of the lower-layer and upper-layer can be directly carried out by the common center transporting machine 6, and the apparatus configuration can be simplified.

Upon rough cleaning in the former side in the lower-layer cleaning line 2A, the pure water used in precision cleaning in the cleaning processing chamber in the latter side in the upper-layer cleaning line 2B can be reutilized as the washing water for the rough cleaning, and the usage amount of pure water can be reduced.

The clean air supplied to the cleaning processing chamber, which carries out precision cleaning in the upper-layer cleaning line 2B, is reutilized as the air for the clean ambient of the cleaning processing chamber, which carries out rough cleaning in the lower-layer cleaning line 2A; thus, the cost of clean air supplying equipment can be reduced.

Transmission of the vibration generated upon operation of at least the cleaning processing chambers 2e to h in the upper-layer cleaning line 2B to the other cleaning processing chambers, each of the transporting machines, or the like can be suppressed; thus, always stable cleaning performance and transport of the wafer can be carried out.

The cleaning processing function of the entire cleaning apparatus is always maintained; thus, defects are not generated in in-process wafers W of pretreatment or the like.

In accordance with the cleaning treatment processes, or the like of the wafers W, the plurality of cleaning processing chambers 2a to 2d and 2e to 2h in each of the cleaning lines 2A and 2B can be replaced or rearranged to an optimal arrangement.

Various modifications can be made in the present invention without departing the spirit of the present invention, and it goes without saying that the present invention pertains to the modifications.

What is claimed is:

1. A cleaning apparatus comprising:
cleaning lines comprised of lower and upper two levels, each of the levels comprising a plurality of cleaning processing chambers which subjects a wafer, which has undergone polishing, to a required cleaning process and drying;
a center transporting means comprising a function of transporting the wafer, which has undergone polishing, into or transporting the processed wafer from each of the cleaning processing chambers in the lower-layer and upper-layer cleaning lines; and
an inter-chamber transporting means for sequentially transporting the wafer to the adjacent cleaning processing chamber in each of the lower-layer and upper-layer cleaning lines.

2. The cleaning apparatus according to claim 1, wherein,
even when either one of the lower-layer or upper-layer cleaning lines is stopped, the other cleaning line can be operated.

3. The cleaning apparatus according to claim 1 or 2, wherein
each of the cleaning processing chambers in the lower-layer and upper-layer cleaning lines can be replaced by another cleaning processing chamber with approximately the same outer shape.

4. A cleaning apparatus comprising:
cleaning lines comprised of lower and upper two levels, each of the levels comprising a plurality of cleaning processing chambers which subjects a wafer, which has undergone polishing, to a required cleaning process and drying;
a center transporting means comprising a function of transporting a wafer to be processed into or transporting the processed wafer from each of the cleaning processing chambers in the lower-layer and upper-layer cleaning lines;
an inter-chamber transporting means for sequentially transporting the wafer to the adjacent cleaning processing chamber in each of the lower-layer and upper-layer cleaning lines; and
an introducing means for introducing pure water used in the cleaning processing chamber, which carries out precision cleaning in a latter side in the upper-layer cleaning line, into the cleaning processing chamber, which carries out rough cleaning in a former side in the lower-layer cleaning line, as washing water for the rough cleaning.

5. The cleaning apparatus according to claim 4, wherein
the introducing means comprising a washing water retention chamber for temporarily retaining the pure water used in the cleaning processing chamber for carrying out precision cleaning, washing water piping connecting the washing water retention chamber to the cleaning processing chamber for carrying out the rough cleaning, and a regulating valve provided in the washing water piping for regulating supplying of the washing water to the cleaning processing chamber, which carries out the rough cleaning.

6. The cleaning apparatus according to claim 4 or 5, wherein the introduction of the washing water by the introducing means from the cleaning processing chamber, which carries out precision cleaning, to the cleaning processing chamber, which carries out the rough cleaning, is carried out by difference in the head of water between the upper-layer cleaning line and the lower-layer cleaning line.

7. The cleaning apparatus according to claim 4, 5, or 6, wherein
the cleaning processing chamber, which carries out precision cleaning in the latter side in the upper-layer cleaning line, is communicated with the cleaning processing chamber, which carries out the rough cleaning in the former side in the lower-layer cleaning line, by an air duct, and clean air supplied from a clean air supplying unit to the cleaning processing chamber, which carries out the precision cleaning, is sent to the cleaning processing chamber, which carries out the rough cleaning, via the air duct.

8. The cleaning apparatus according to claim 4, 5, 6, or 7, wherein
the wafer, which has undergone polishing, is subjected to a required cleaning process including the rough cleaning in the cleaning processing chamber in the former side in the lower-layer cleaning line, and the wafer is then transported to the cleaning processing chamber in the latter side in the upper-layer cleaning line by the center transporting means and subjected to a required cleaning process including the precision cleaning and a drying process so as to subject the wafer to a series of required processes.

9. The cleaning apparatus according to claim 4, 5, 6, 7, or 8, wherein
at least each of the cleaning processing chambers in the upper-layer cleaning line is attached to an apparatus frame via an anti-vibration means.

10. The cleaning apparatus according to claim 4, 5, 6, 7, 8, or 9, wherein
even when either one of the cleaning lines of the lower-layer or upper-layer cleaning lines is stopped, the other cleaning line can be operated.

11. The cleaning apparatus according to claim 4, 5, 6, 7, 8, 9, or 10, wherein
each of the cleaning processing chambers in the lower-layer and upper-layer cleaning lines can be replaced by another cleaning processing chamber comprising an approximately the same outer shape.
